(19) United States
(12) Patent Application Publication
(10) Pub. No.: US 2007/0062793 A1
(43) Pub. Date: Mar. 22, 2007

(54) LIGHT GUIDE FOR ILLUMINATING A KEYPAD

(75) Inventor: PEI-YU HUNG, TUCHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/308,582

(22) Filed: Apr. 8, 2006

(30) Foreign Application Priority Data
Sep. 16, 2005 (CN) 200510037365.2

(51) Int. Cl. H01H 9/00

(52) U.S. Cl. 200/310

(57) ABSTRACT

A light guide (30) for illuminating a keypad (20) including a plurality of keys (22) includes a plurality of apertures (300) corresponding to the keys, and an accommodating portion. The accommodating portion defines at least one receiving hole (320) for receiving at least one light source. A thickness of the light guide gradually reduces from the accommodating portion to surrounding portions of the light guide along at least one direction.

### FIELD OF THE INVENTION

The invention relates to light guides, and particularly to a light guide for illuminating a keypad or keyboard uniformly.

### DESCRIPTION OF RELATED ART

It is common to illuminate a keyboard or keypad of an electronic device, such as a mobile telephone, to facilitate nighttime use. Each individual key may be illuminated by a respective light source located directly behind the key. This arrangement is, however, very expensive since a separate light source is required for each key. Furthermore, the power dissipation of the mobile telephone is increased, and the standby time of the mobile telephone is shorter.

A more economical approach utilizes fewer distributed light sources and the light is directed towards the keys with the aid of a light guide in the form of a transparent plate. Referring to FIG. 6, a plan view of a conventional light guide 50 is shown. The light guide 50 comprises a plurality of V-shaped notches 52 defined at a periphery thereof, and an array of apertures 520 arranged in four rows and three columns. The apertures 520 are rectangular with rounded corners, corresponding to keys 60 of a keypad. Four light sources, such as light-emitting diodes, are located behind the light guide 50. In a vicinity of each of the light sources, the light guide 50 comprises a respective convex lens 70 formed integrally therewith. Aligned with the lens 70, adjacent to a front face of the light guide 50, there is provided a prismatic indentation 72, which offers four reflecting surfaces each having a triangular outline. The light from the light source is collimated by the lens 70 into a beam traveling transversely into the light guide 50, then the prismatic indentation 72 serves to direct the beam into a plane of the light guide 50 by means of total internal reflection to illuminate the keys 60. However the number of the light sources is four, and the power dissipation of the mobile telephone is still too great. In addition, the illumination is not uniform as the brightness of the keys 60 adjacent to the light source is greater than that of the keys 60 away from the light source, and the cost of manufacturing the light guide 50 is greater because the lens 70 is formed integrally with the light guide 50.

Therefore, a heretofore unaddressed need exists in the industry to overcome the aforementioned deficiencies and inadequacies.

### SUMMARY OF INVENTION

In an exemplary embodiment, a light guide for illuminating a keypad including a plurality of keys, comprises a plurality of apertures corresponding to the keys, and an accommodating portion. The accommodating portion defines at least one receiving hole for receiving at least one light source. A thickness of the light guide gradually reduces from the accommodating portion to surrounding portions of the light guide along at least one direction.

Other advantages and novel features will become more apparent from the following detailed description of preferred embodiments when taken in conjunction with the accompanying drawings, in which:

### BRIEF DESCRIPTION OF DRAWINGS

FIG. 1 is an exploded, isometric view of an electronic device of an exemplary embodiment of the present invention, the electronic device comprising a keypad and a light guide;

FIG. 2 is an enlarged, inverted, isometric view of the light guide of FIG. 1;

FIG. 3 is a cross-sectional view along line IV-IV of FIG. 3;

FIG. 4 is a schematic diagram of the light reflecting in the light guide of FIG. 1;

FIG. 5 is an inverted, assembled view of FIG. 1; and

FIG. 6 is a plan view of a conventional light guide.

### DETAILED DESCRIPTION

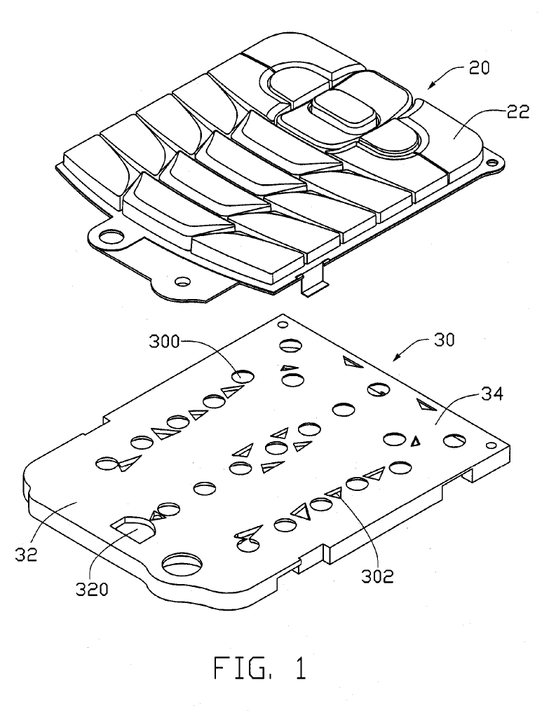

Referring to FIGS. 1 and 5, an electronic device 1 0 of an exemplary embodiment of the present invention comprises a keyboard 20 and a light guide 30.

The keypad 20 has a generally rectangular profile. The keypad 20 comprises a plurality of keys 22. Each of the keys 22 comprises a key column 220.

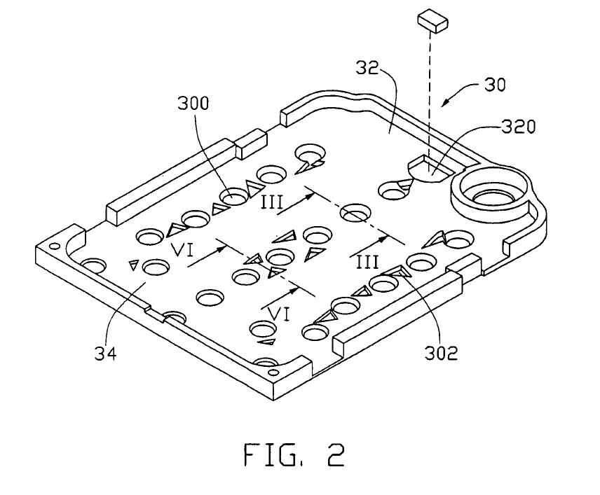

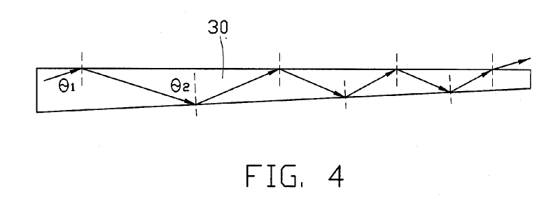

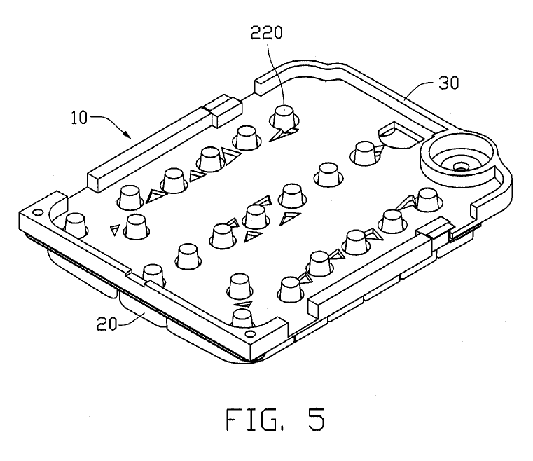

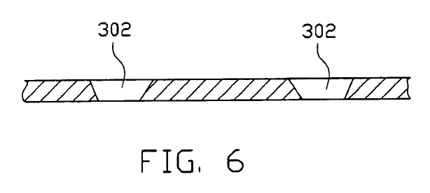

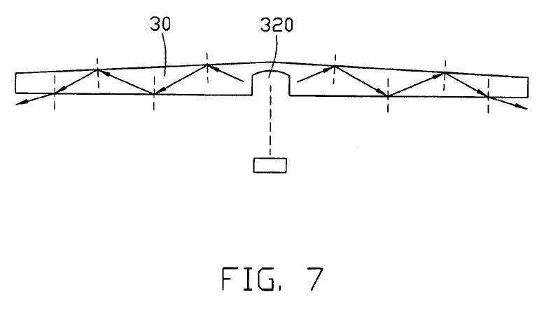

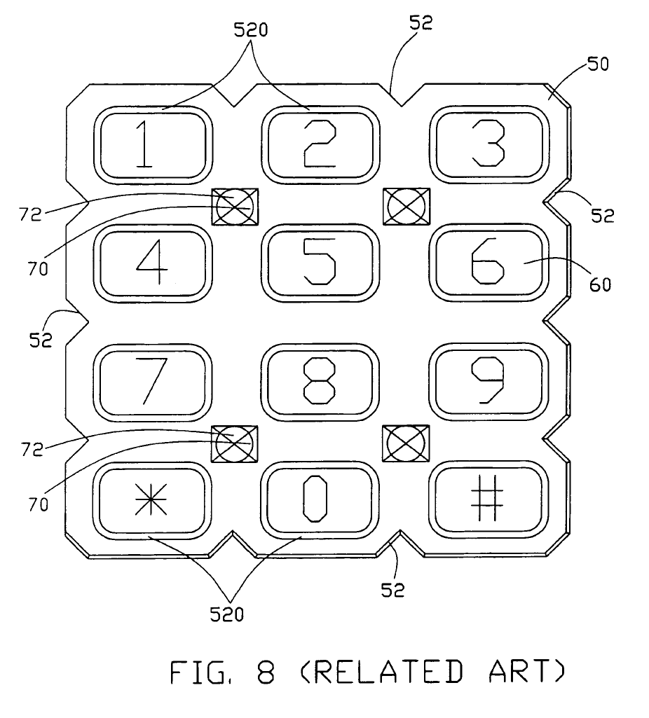

Referring also to FIGS. 2 and 4, the light guide 30 can be mounted on a circuit board comprising a light source, for example, a light-emitting diode (not shown). The light guide 30 is a transparent plate. Lengthwise, in cross section, the light guide 30 is generally wedge-shaped. The light guide 30 comprises a first end portion 32 and a second end portion 34. A thickness of the light guide 30 gradually reduces from the first end portion 32 to the second end portion 34. The light guide 30 further comprises an accommodating portion disposed in the first end portion 32. A receiving hole 320 is defined in the accommodating portion, for receiving the light source.

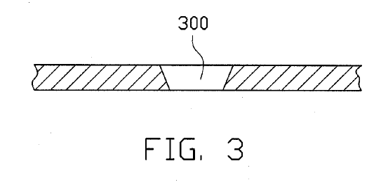

Referring also to FIG. 3, the light guide 30 comprises a plurality of apertures 300 corresponding to the keys 22 of the keypad 20. The key columns 220 of the keys 22 are received in the corresponding apertures 300. Each of the apertures 300 is a tapered through-hole. A radius of an end portion of each aperture 300 adjacent to the circuit board is greater than that of the other end portion of each aperture 300 adjacent to the keypad 20, thereby the light from the light source can be easily introduced into the keys 22, and illuminate the keys 22 uniformly.

The light guide 30 also comprises a plurality of holes 302 each disposed near each aperture 300. Each hole 302 is tapered and triangular shaped. A width of an end portion of each hole 320 adjacent to the circuit board is greater than that of the other end portion of each hole 320 adjacent to the keypad 20, thereby, the light from the light source can be easily introduced into the keypad 20 along all directions, and can illuminate the keypad 20 uniformly.

In assembly, the key columns 220 of the keypad 20 are received in the corresponding apertures 300 of the light guide 30.

In use, the light from the light source received in the receiving hole 320 is introduced into the light guide 30, and an angle of incidence is designated as θ1. After the light first reflects within the light guide 30, a second angle of incidence is designated as 02. Because of the wedge shape of the light guide 30, and the light source being received in the receiving hole 320 of the first end portion 32 having the greater thickness, the angle θ1 is greater than the angle θ2. After each reflection of the light, the incident angles becomes more acute and the distance between deflection points reduces gradually from the first end portion 32 to the second end portion 34. In this way, the loss of illuminating power as the light travels through the light guide 30 is compensated for by the increase in density of the number of reflections over distance. Thus, a brightness of the portion of the light guide 30 away from the light source is comparable to a brightness of the portion of the light guide 30 near the light source, so that a uniform brightness is obtained. Furthermore, the number of the light sources used in the electronic device 10 is reduced, and the standby time of the electronic device 10 is prolonged.

In an alternative embodiment, the light guide 30 may be mound-shaped with the accommodating portion defining the receiving hole 320 disposed in a middle portion of the light guide 30, which has a greater thickness than surrounding portions. As above, the angle of incidence of the light reflecting within the light guide 30 becomes more acute gradually as it travels away from the light source in the middle portion of the light guide 30 to the surrounding portions. Thus, uniform illumination by the light source is achieved.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A light guide for illuminating a keypad, wherein the keypad includes a plurality of keys, the light guide comprising:
a plurality of apertures, corresponding to the keys; and
an accommodating portion defining at least one receiving hole for receiving at least one light source;
wherein a thickness of the light guide gradually reduces from the accommodating portion to surrounding portions of the light guide along at least one direction.

2. The light guide as claimed in claim 1, wherein each of the apertures is a tapered through-hole.

3. The light guide as claimed in claim 1, further comprising a plurality of holes disposed near the apertures, respectively.

4. The light guide as claimed in claim 3, wherein each of the holes is tapered and triangular shaped.

5. The light guide as claimed in claim 1, further comprising a first end portion and a second end portion, the accommodating portion disposed in the first end portion.

6. The light guide as claimed in claim 5, wherein lengthwise, in cross section, the light guide is generally wedge-shaped, and the thickness of the light guide gradually reduces from the first end portion to the second end portion.

7. The light guide as claimed in claim 1, wherein the accommodating portion is disposed in a middle portion of the light guide.

8. The light guide as claimed in claim 7, wherein the light guide is generally mound-shaped, and the thickness of the light guide gradually reduces from the accommodating portion to other portions of the light guide along all directions.

9. An electronic device, comprising:
a keypad comprising a plurality of keys;
a light guide disposed under the keypad, the light guide comprising a plurality of apertures corresponding to the keys, and an accommodating portion defining at least one receiving hole; and
at least one light source received in the at least one receiving hole of the light guide;
wherein a thickness of the light guide gradually reduces from the accommodating portion to surrounding portions of the light guide along at least one direction.

10. The electronic device as claimed in claim 9, wherein each of the apertures is a tapered through-hole.

11. The electronic device as claimed in claim 9, further comprising a plurality of holes disposed near the apertures, respectively.

12. The electronic device as claimed in claim 11, wherein each of the holes is tapered and triangular shaped.

13. The electronic device as claimed in claim 9, further comprising a first end portion and a second end portion, the accommodating portion disposed in the first end portion.

14. The electronic device as claimed in claim 13, wherein lengthwise, in cross section, the light guide is a generally wedge-shaped, and the thickness of the light guide gradually reduces from the first end portion to the second end portion.

15. The electronic device as claimed in claim 9, wherein the accommodating portion is disposed in a middle portion of the light guide.

16. The electronic device as claimed in claim 15, wherein the light guide is generally mound-shaped, and the thickness of the light guide gradually reduces from the accommodating portion to other portions of the light guide along all directions.

17. An electronic device comprising:
a keypad of said electronic device facing outside said electronic device for user operation, said keypad comprising a plurality of keys, and each of said plurality of keys movable relative to said keypad to enable at least one predetermined function of said electronic device in a position thereof, and to disable said at least one predetermined function when said each of said plurality of keys moves away from said position thereof;
at least one light source installable beside said keypad;
an integrally-formed light guide installable between said keypad and said at least one light source so as to accept light from said at least one light source and transmit said light toward said each of said plurality of keys for illumination, said light guide comprising a plurality of holes selectively neighboring said plurality of keys respectively, each of said plurality of holes having an end portion facing said keypad sized smaller than another end portion of said each of said plurality of holes facing oppositely.

18. The electronic device as claimed in claim 17, wherein a key column extends from said each of said plurality of keys into and through said light guide, and said plurality of holes selectively extend around said key column.
